(19) United States
(12) Patent Application Publication
(10) Pub. No.: US 2025/0168473 A1
(43) Pub. Date: May 22, 2025

(54) PROGRAMMATIC MEDIA PREVIEW GENERATION

(71) Applicant: Tubi, Inc., San Francisco, CA (US)

(72) Inventors: Aidean Sharghi Karganroodi, Pearland, TX (US); Venkatesh Ganapati Hegde, San Ramon, CA (US); Michael Edward Depies, El Segundo, CA (US); Evan Lennon Aubrey, Berkeley, CA (US); Alexis Franklin, Los Angeles, CA (US); Zhiye Li, Southlake, TX (US); Jaya Kawale, San Jose, CA (US); Amir Mazaheri, Mountain View, CA (US)

(73) Assignee: Tubi, Inc., San Francisco, CA (US)

(21) Appl. No.: 19/033,398

(22) Filed: Jan. 21, 2025

Related U.S. Application Data
(63) Continuation-in-part of application No. 18/301,965, filed on Apr. 17, 2023.
(63) Continuation-in-part of application No. 18/964,224, filed on Nov. 29, 2024.
Application No. 18/964,224 is a continuation of application No. 18/301,971, filed on Apr. 17, 2023, now Pat. No. 12,192,600.

(51) Int. Cl. H04N 21/8549; G11B 27/19; H04N 21/233; H04N 21/234; H04N 21/81; H04N 21/845

(52) U.S. Cl. CPC H04N 21/8549; G11B 27/19; H04N 21/233; H04N 21/23418; H04N 21/812; H04N 21/8456

(57) ABSTRACT

A system and method for programmatic media preview generation, including: a preview generation system executing on a computer processor and configured to receive a request to generate a preview video of a source video file; select a source video for analysis; obtain a set of text metadata comprising groupings of subtitles of the source video; invoke a machine learning model using the set of text metadata to infer a set of candidate previews for the source video file; and provide a final set of candidate previews in response to the request; and a ranking module comprising functionality to rank the set of candidate previews to generate the final set of candidate previews.

### CROSS-REFERENCE TO RELATED APPLICATIONS

This application is a continuation-in-part of co-pending U.S. patent application Ser. No. 18/301,965, Attorney Docket tubi.00012.us.n.1, entitled “ADVERTISEMENT BREAK DETECTION,” filed Apr. 17, 2023, including inventors Amir Mazaheri, Jaya Kawale, and others, the entire disclosure of which is incorporated by reference herein, in its entirety, for all purposes.

This application is a continuation-in-part of co-pending U.S. patent application Ser. No. 18/964,224, Attorney Docket tubi.00013.us.c.1, entitled “MULTIMEDIA SCENE BREAK DETECTION,” filed Nov. 29, 2024, including inventors Amir Mazaheri, Jaya Kawale, and others, the entire disclosure of which is incorporated by reference herein, in its entirety, for all purposes. U.S. patent application Ser. No. 18/964,224 is a continuation of co-pending U.S. patent application Ser. No. 18/301,971, Attorney Docket tubi.00013.us.n.1, entitled “MULTIMEDIA SCENE BREAK DETECTION,” filed Apr. 17, 2023, including inventors Amir Mazaheri, Jaya Kawale, and others, the entire disclosure of which is incorporated by reference herein, in its entirety, for all purposes.

### BACKGROUND

The exponential growth of media content, particularly in video formats, has led to significant advancements in how users interact with, consume, and navigate digital media. In recent years, media streaming platforms, social media networks, and digital video services have increasingly focused on enhancing user engagement by improving content discovery and personalization mechanisms. Video previews, including short clips and summary segments, have become a widely used tool for enhancing user experience by providing quick insights into longer video content. These previews are often employed to give users a sense of what a video contains, enabling them to make more informed decisions about what to watch without committing to the full-length content.

Media providers have long recognized the importance of offering a quick and concise summary of video content to capture user attention. Traditionally, this task has been handled through manual processes, where editors or content curators carefully select segments of video content to generate brief previews. These previews serve as a way to give users a snapshot of the full video, helping them decide whether or not to engage with the video. However, as media libraries have expanded, the reliance on manual curation has posed challenges in terms of scale and efficiency.

As video content has continued to grow exponentially in both volume and variety, the demand for scalable solutions to assist in the generation of engaging media previews has become apparent. Media platforms seek to improve content discovery by providing users with engaging and relevant previews that summarize key aspects of the video. These previews can be used across various platforms, including mobile devices, web-based services, and connected home entertainment systems, where quick and efficient content presentation is critical to retaining user engagement.

The continuous evolution of media consumption patterns, coupled with the increasing volume of content available, has driven a need for more advanced methods to create and deliver these previews. The ability to present users with highly relevant, easily digestible previews of video content remains a central component of modern media distribution strategies, enabling users to make informed decisions about their viewing choices in an increasingly crowded digital landscape.

### SUMMARY

In general, in one aspect, embodiments relate to systems and methods for programmatic media preview generation. Each media item is ingested and analyzed by multiple components of the system to perform multiple analyses of the audio and/or video components of the source media. Multiple candidate previews are generated as part of this analysis. A ranking process is then utilized to prune and/or rank the results into a final set of previews for the media item. This final set of previews can then be directly deployed to a production environment, and/or can be surfaced for administrator approval/review in accordance with various embodiments of the invention.

In general, in one aspect, embodiments relate to a system for programmatic media preview generation. The system can include a computer processor, a preview generation system executing on the computer processor and comprising functionality to receive a request to generate a preview video of a source video file; select a source video for analysis; obtain a set of text metadata comprising groupings of subtitles of the source video, wherein each grouping comprises at least one timestamp indicating an occurrence of the subtitles during the source video file; invoke a machine learning model using the set of text metadata to infer a set of candidate previews for the source video file, wherein each of the set of candidate previews is a structured data representation of a segment of the source video, and wherein each structured data representation comprises a synopsis of the corresponding segment; and provide a final set of candidate previews in response to the request; and a ranking module comprising functionality to rank the set of candidate previews to generate the final set of candidate previews.

In general, in one aspect, embodiments relate to a method for programmatic media preview generation. The method can include: receiving a request to generate a preview video of a source video file; selecting a source video for analysis; obtaining a set of text metadata comprising groupings of subtitles of the source video, wherein each grouping comprises at least one timestamp indicating an occurrence of the subtitles during the source video file; invoking, by a computer processor, a machine learning model using the set of text metadata to infer a set of candidate previews for the source video file, wherein each of the set of candidate previews is a structured data representation of a segment of the source video, and wherein each structured data representation comprises a synopsis of the corresponding segment; ranking the set of candidate previews to generate a final set of candidate previews; and providing the final set of candidate previews in response to the request.

In general, in one aspect, embodiments relate to a non-transitory computer-readable storage medium having instructions for programmatic media preview generation. The instructions are configured to execute on at least one computer processor to enable the computer processor to: receive a request to generate a preview video of a source video file; select a source video for analysis; obtain a set of text metadata comprising groupings of subtitles of the source video, wherein each grouping comprises at least one timestamp indicating an occurrence of the subtitles during the source video file; invoke a machine learning model using the set of text metadata to infer a set of candidate previews for the source video file, wherein each of the set of candidate previews is a structured data representation of a segment of the source video, and wherein each structured data representation comprises a synopsis of the corresponding segment; rank the set of candidate previews to generate a final set of candidate previews; and provide the final set of candidate previews in response to the request.

Other embodiments will be apparent from the following description and the appended claims.

### BRIEF DESCRIPTION OF THE DRAWINGS

Embodiments are illustrated by way of example, and not by way of limitation, in the figures of the accompanying drawings and in which like reference numerals refer to similar elements.

FIGS. 1A-1C show schematic diagrams of a media platform, in accordance with one or more embodiments.

FIG. 2 shows an example output of a speech-to-text process, in accordance with one or more embodiments.

FIG. 3 shows a partial structured representation of a set of text synopses, in accordance with one or more embodiments.

FIG. 4 shows a flow diagram depicting a process for programmatic media preview generation, in accordance with one or more embodiments.

FIG. 5 shows a flowchart depicting a process for programmatic media preview generation, in accordance with one or more embodiments.

FIGS. 6 and 7 show a computing system and network architecture in accordance with one or more embodiments.

### DETAILED DESCRIPTION

A portion of the disclosure of this patent document may contain material that is subject to copyright protection. The copyright owner has no objection to the facsimile reproduction by anyone of the patent document or the patent disclosure, as it may appear in the Patent and Trademark Office patent file or records, but otherwise reserves all copyrights whatsoever.

Specific embodiments will now be described in detail with reference to the accompanying figures. Like elements in the various figures are denoted by like reference numerals for consistency. In the following detailed description of embodiments, numerous specific details are set forth in order to provide a more thorough understanding of the invention. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It will be apparent to one of ordinary skill in the art that the invention can be practiced without these specific details. In other instances, well-known features have not been described in detail to avoid unnecessarily complicating the description.

In general, embodiments of the present disclosure provide methods and systems for generating and utilizing media previews. Multiple system components are utilized to ingest a media item and to perform a variety of different analyses of the media item. One or more of these processes may optionally be performed in parallel. A set of candidate previews is generated and ranked based on the outputs of the analysis, and a final set of candidate previews is made available for human review and/or deployment to a media platform.

In general, embodiments of the present disclosure provide methods and systems for programmatic media preview generation. A data pipeline ingests a media item in an offline process. The offline process triggers one or more preview generation analyses that may include, but is not limited to, any number of the following: input selection and trimming, shot detection, content moderation, entity recognition, text metadata extraction/generation, and text synopsis generation, and candidate preview ranking/outlier detection.

The systems and methods outlined in this disclosure encompass functionality for preview generation across diverse types of media and content. While many of the described systems and processes use video as an illustrative example, it is important to emphasize that these approaches are applicable to a wide array of data types and formats. This includes, but is not limited to, books, podcasts, music albums, academic papers, news articles, blog posts, social media content, educational courses, and interactive digital experiences. The preview generation capabilities described herein can be effectively applied to any form of content that is disseminated to audiences, whether it be for entertainment, information, education, or other purposes.

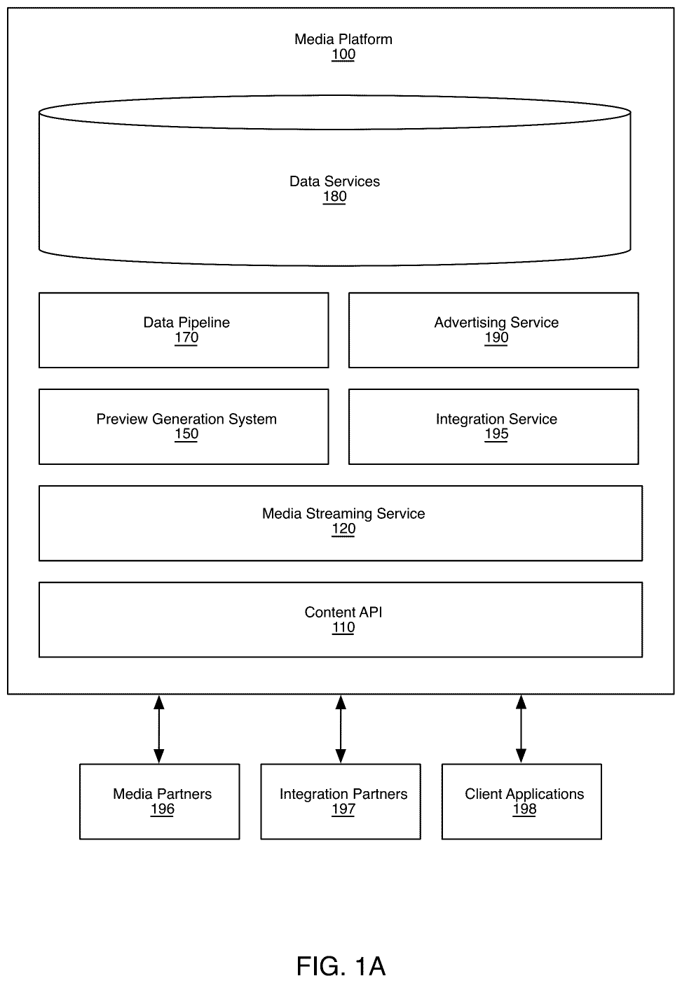

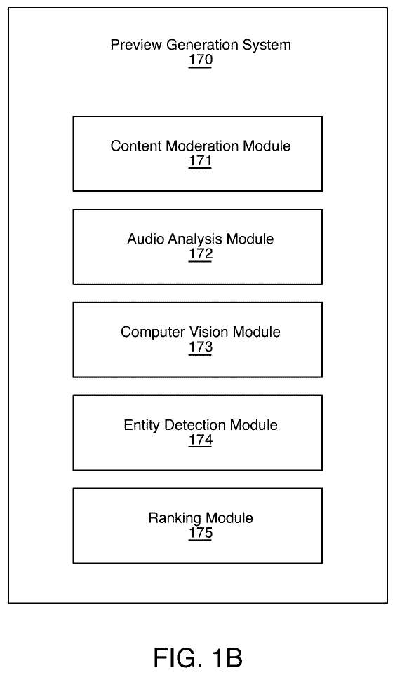

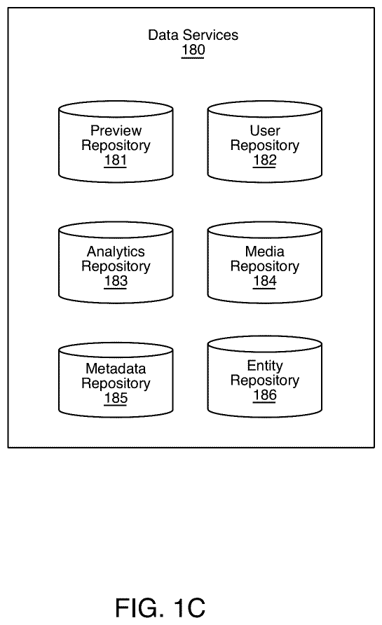

FIG. 1A shows a media platform 100 in communication with media partners 196, integration partners 197, and client applications 198, in accordance with one or more embodiments. As shown in FIG. 1A, the media platform 100 has multiple components including a data pipeline 170, a preview generation system 150, a media streaming service 120, a content application programming interface (API) 110, an advertising service 190, an integration service 195, and a variety of data services 180. Various components of the media platform 100 can be located on the same device (e.g., a server, an elastic compute device orchestrated by a cloud service provider, a mainframe, desktop personal computer (PC), laptop, mobile device, kiosk, cable box, and any other device) or can be located on separate devices connected by a network (e.g., a virtual private cloud (VPC), a local area network (LAN), the Internet, etc.). Those skilled in the art will appreciate that there can be more than one of each separate component running on a device, as well as any combination of these components within a given embodiment.

In one or more embodiments, the media platform 100 is a platform for facilitating streaming, playback, ingestion, analysis, and search of media-related content. For example, the media platform 100 may store or be operatively connected to services storing millions of media items such as movies, user-generated videos, music, audio books, and any other type of media content. The media content may be provided for viewing by end users of a video or audio streaming service (e.g., media streaming service 120), for example. Media services provided by the media platform 100 can include, but are not limited to, generation and utilization of media previews and other functionality disclosed herein.

In one or more embodiments of the invention, the media platform 100 is a technology platform including multiple software services executing on different novel combinations of hardware devices. The components of the media platform 100, in the non-limiting example of FIG. 1A, are software services implemented as containerized applications executing in a cloud environment. The preview generation system 150 and related components can be implemented using specialized hardware to enable parallelized analysis and performance. Other architectures can be utilized in accordance with the described embodiments.

In one or more embodiments of the invention, preview generation system 150, media streaming service 120, and the content application programming interface (API) 110 are software services or collections of software services configured to communicate both internally and externally of the media platform 100, to implement one or more of the functionalities described herein. The systems described in the present disclosure may depict communication and the exchange of information between components using directional and bidirectional lines. Neither is intended to convey exclusive directionality (or lack thereof), and in some cases components are configured to communicate despite having no such depiction in the corresponding figures. Thus, the depiction of these components is intended to be exemplary and non-limiting.

In one embodiment of the invention, the media generation system 150 is a component of the data pipeline 170. The arrangement of the components and their corresponding architectural design are depicted as being distinct and separate for illustrative purposes only. Many of these components can be implemented within the same binary executable, containerized application, virtual machine, pod, or container orchestration cluster. Performance, cost, and application constraints can dictate modifications to the architecture without compromising function of the depicted systems and processes.

Although the components of the media platform 100 are depicted as being directly communicatively coupled to one another, this is not necessarily the case. For example, one or more of the components of the media platform 100 may be communicatively coupled via a distributed computing system, a cloud computing system, or a networked computer system communicating via the Internet.

The preview generation system 150 is responsible for executing and/or orchestrating the various tasks involved in generating media previews. In one or more embodiments of the invention, the preview generation system 150 includes several functional components such as the audio analysis module 172, computer vision module 173, and ranking module 175. The preview generation system 150 is configured to interact with various repositories, including the media repository 184 and metadata repository 185, to access the necessary video and metadata files required for generating previews. The system manages the processing flow from receiving the input video file to outputting the ranked media previews.

In one or more embodiments of the invention, the preview generation system 150 includes functionality to receive a request to generate a preview video for a source video file. This request may originate from various sources, including client applications 198, media partners 196, or integration partners 197, through an API call or other communication protocols. The request may include metadata about the source video, such as the title, duration, and format of the video file, along with optional parameters like the desired length of the preview or restrictions on content. For example, the request may specify that the generated preview should be no longer than 60 seconds or that certain scenes should be excluded based on content moderation requirements. In one embodiment of the invention, the request for preview generation happens as part of an offline ingestion process of the data pipeline 170, which occurs when a media item is ingested by the media platform 100.

Once a request is received, the preview generation system identifies the source video in the media repository 184. In one or more embodiments, the media repository 184 stores video files in various formats, such as MP4, MKV, or MOV, and the preview generation system retrieves the appropriate file for analysis. The system may also retrieve metadata associated with the source video, such as subtitle files, audio tracks, and existing scene markers, to aid in the preview generation process. The selected source video may be trimmed to a specified or predefined portion, such as the first 30 minutes, to avoid spoilers or unnecessary processing of later parts of the content.

In one or more embodiments of the invention, the preview generation system 150 includes functionality to obtain text metadata corresponding to the media file. For purposes of this disclosure, text metadata can refer to any textual information that is associated with or derived from the media file and can be used to represent, describe, or summarize the content of the media. This metadata can originate from various sources, including but not limited to, audio transcriptions, subtitles, closed captions, or descriptive text generated from external services. In some embodiments, text metadata may also be obtained from external databases, metadata repositories 185, or be generated dynamically via analysis of the media file's audio and visual content.

Examples of text metadata can include, but are not limited to: subtitles embedded in the media file, closed captions used for accessibility purposes, audio descriptions, transcriptions of dialogue generated through speech-to-text algorithms, descriptions or summaries provided by human curators, and textual annotations derived from scene or event recognition within the media file. In some cases, text metadata may also encompass structured data representations of media segments, such as JSON objects that contain timestamps, segment descriptions, and key plot points. Additionally, text metadata can include annotations related to content moderation, such as flagged words or phrases that indicate the presence of profanity or sensitive topics, as well as entity recognition data indicating the presence of specific actors, characters, or objects within the video.

In one or more embodiments of the invention, the preview generation system 150 invokes a machine learning model to infer a set of candidate previews based on the obtained text metadata and other inputs. The machine learning model may utilize a variety of inputs, including the subtitles, scene descriptions, and structured data representations, to generate candidate previews. Each candidate preview is represented as structured data, which may include a synopsis of the corresponding segment, start and end timestamps, and key features of the segment, such as important dialogue or visual events. For example, the machine learning model might analyze the subtitles and determine that a particular minute-long segment of a movie, where two characters engage in a crucial conversation, should be included as a candidate preview.

After generating the candidate previews, the preview generation system 150 provides a final set of these previews in response to the initial request. In one or more embodiments of the invention, the final set may be provided to a client application or a media platform for display to users. The preview generation system may also output the set in a structured format, such as JSON, which includes details about each candidate preview, including the start and end times, a synopsis, and metadata about the segment's relevance to the overall media. The system may generate different preview sets for different use cases, such as personalized previews for specific user profiles based on user behavior data from the user repository 182.

In one or more embodiments of the invention, the ranking module 175 is responsible for ranking the set of candidate previews to determine which previews are most suitable for presentation. The ranking process involves analyzing various factors such as the presence of key actors, relevance of the scene to the overall plot, and content moderation scores. For example, the ranking module may assign higher scores to previews that feature well-known actors or pivotal plot points, while downranking previews that include potentially inappropriate content or are less relevant to the user's preferences. The ranked previews are then filtered to ensure that the highest-scoring previews are selected for final output.

### Data Services

FIG. 1C shows data services 180, in accordance with one or more embodiments. As shown in FIG. 1C, data services 180 has multiple components including a document repository 181, a user repository 182, an analytics repository 183, a media repository 184, a metadata repository 185, and an entity repository 186. Various components of the data services 180 can be located on the same device (e.g., a server, an elastic compute device orchestrated by a cloud service provider, a mainframe, desktop personal computer (PC), laptop, mobile device, kiosk, cable box, and any other device) or can be located on separate devices connected by a network (e.g., a virtual private cloud (VPC), a local area network (LAN), the Internet, etc.). Those skilled in the art will appreciate that there can be more than one of each separate component running on a device, as well as any combination of these components within a given embodiment.

In one or more embodiments of the invention, each data service (181, 182, 183, 184, 185, 186) of the data services 180 includes both business logic and/or storage functionality. For purposes of this disclosure, the terms “repository” and “store” may refer to a storage system, database, database management system (DBMS), or other storage related technology, including persistent or non-persistent data stores, in accordance with various embodiments of the invention.

In one or more embodiments of the invention, each repository includes both persistent and non-persistent storage systems, as well as application logic configured to enable performant storage, retrieval, and transformation of data to enable the functionality described herein. Non-persistent storage such as Redis, Memcached, and an in-memory data store can be utilized to cache data in order to increase performance of frequently accessed data and reduce the latency of requests.

In one or more embodiments of the invention, the media repository 184 includes functionality to store media items. Media items can include both source media items, advertising media items, and derived media items such as previews or clips, and can comprise media types and file formats of various types. Examples of media items can include, but are not limited to, movies, television shows, series, episodes, video episodes, podcasts, music, audiobooks, documentaries, concerts, live event recordings, news broadcasts, educational content, instructional videos, sports events, video blogs (vlogs), reality shows, animations, short films, trailers, behind-the-scenes footage, interviews, and user-generated content. Each of these media items can be stored, categorized, and retrieved in multiple formats such as MP4, AVI, WMV, MOV, MP3, WAV, FLAC, and others.

In one or more embodiments of the invention, the preview repository 181 includes functionality to store structured data representations of media previews. These structured data representations may take the form of JSON objects or other suitable formats that encapsulate various metadata corresponding to the media item. Such metadata can include, but is not limited to, synopses of the media preview, start and end timestamps for each preview segment (or a set of timestamps in the scenario where the preview is constructed of multiple stitched segments), descriptions of key events or scenes, and annotations related to content moderation or entity recognition. In some embodiments, the JSON objects may further contain additional information such as the identification of significant actors, genre classifications, and details about the structure of the media, such as scene or shot boundaries.

In cases where a preview is created by stitching together multiple segments from different parts of the media, the structured data representation stores a set of timestamps corresponding to the start and end times of each individual segment. These timestamps provide the necessary temporal markers to identify where each segment originates from within the source media file. For example, if a preview consists of three stitched segments taken from different parts of the video (e.g., an action scene from the beginning, a dramatic dialogue in the middle, and a climax at the end), the structured data would include the start and end times for each of these segments. This allows the system to keep track of the specific points in the media from which the preview is constructed.

In one example, a structured data representation for a movie preview might include a synopsis of a particular one-minute clip, a timestamp indicating that the clip begins at minute 10 and ends at minute 11, and metadata indicating the presence of a well-known actor within that segment. The preview repository 181 can also store multiple candidate previews for the same media item, enabling ranking and selection processes or human curators to access this data when determining which preview to present to users. In one or more embodiments, this data can be accessed and updated dynamically, allowing for modifications based on user feedback, curator input, or automated model refinements.

In one or more embodiments of the invention, the user repository 182 includes functionality to store data associated with one or more users of the media platform 100. This data may include, but is not limited to, user preferences, viewing history, interaction patterns, and engagement metrics such as likes, shares, and comments. In some embodiments, the user repository 182 may also store personalized settings, such as preferred genres, languages, or content ratings, along with demographic information that may be voluntarily provided by the user.

This data can be utilized in the preview generation process by enabling the preview generation system 150 to tailor the selection and ranking of media previews based on individual user preferences or behaviors. For example, if a user frequently watches action movies and has a preference for certain actors, this information can be leveraged to prioritize candidate previews that align with these preferences. In one or more embodiments, the stored user data can also be used to track engagement with specific previews, allowing the system to refine future preview recommendations and improve the overall user experience by learning from past interactions.

In one or more embodiments of the invention, metadata repository 185 includes functionality to catalog, store, and facilitate access to a range of metadata. This metadata may include various types of information associated with media files, such as title, genre, cast, director, production details, keywords, content descriptions, and timestamps linked to specific scenes or events within the media. The repository may also store technical metadata, such as file formats, resolution, and encoding parameters, as well as text metadata related to subtitle or closed-captioning information.

In the context of preview generation, the metadata repository 185 may be configured to provide the preview generation system 150 with the necessary context for generating and selecting media previews. For example, the repository 185 can supply information about the cast and genre of the media, which can be used to tailor previews to highlight key actors or emphasize themes that are relevant to the media's genre. Additionally, metadata related to specific scenes, such as timestamps or content summaries, can be used to identify segments of the video that are most suitable for previewing. In one or more embodiments, metadata stored in the repository is dynamically updated and accessed during the preview generation process to ensure the generated previews are relevant, accurate, and aligned with user preferences.

In one or more embodiments of the invention, the analytics repository 183 includes functionality to store analytics data relating to one or more media items. Media items can include encoded media files, media previews, media clips, and media-related advertising content. Examples of analytics data can include, but are not limited to, engagement data relating to a media item, feedback regarding placement of an advertisement, media clip, or media preview, usage data and performance data relating to media items, and feedback utilized as online training data in the training and retraining of one or more machine learning models.

In one or more embodiments of the invention, the entity repository 186 includes functionality to store and manage data related to recognized entities within media content. Entities may include, but are not limited to, people (such as actors, directors, and public figures), places (such as specific locations or landmarks), objects (such as significant items within a scene), and organizations (such as production companies or brands). The entity repository 186 is used to maintain metadata about these entities, including names, roles, and relationships to the media content. For example, it may store information about a well-known actor's appearances in specific scenes or across multiple media titles. In the context of preview generation, the entity repository 186 enables the preview generation system 150 to identify and highlight key entities in media previews. For instance, it can be used to prioritize preview segments that feature prominent actors or relevant branded content, improving the relevance and appeal of the previews based on user interest in specific entities. The entity data can also assist in filtering previews based on content restrictions, such as avoiding spoilers or inappropriate content.

### Media Preview Generation

FIG. 1B shows preview generation system 150 in accordance with one or more embodiments. As shown in FIG. 1B, the preview generation system 150 has multiple components including a content moderation module 171, an audio analysis module 172, a computer vision module 173, an entity detection module 174, and a ranking module 175. Various components of the preview generation system 150 can be located on the same device (e.g., a server, an elastic compute device orchestrated by a cloud service provider, a mainframe, desktop personal computer (PC), laptop, mobile device, kiosk, cable box, and any other device) or can be located on separate devices connected by a network (e.g., a virtual private cloud (VPC), a local area network (LAN), the Internet, etc.). Those skilled in the art will appreciate that there can be more than one of each separate component running on a device, as well as any combination of these components within a given embodiment.

### Pre-Processing

In one or more embodiments of the invention, the preview generation system 150 includes functionality to pre-process the media item in order to constrain, filter, or limit portions of the video that are usable for preview generation. This pre-processing step is utilized to ensure that the selected video segments meet specific content requirements and improve the relevance and appropriateness of the previews. Pre-processing may be performed by the data pipeline 170, which interacts with various system components such as the media repository 184 and the content moderation module 171 to prepare the media item before the preview generation process begins.

One example of pre-processing involves trimming the media item so that only a specific portion of the video is considered for preview generation. For instance, in the case of a movie, the system may be configured to limit the usable content to the first 30 minutes of the film to avoid including spoilers or critical plot reveals in the generated previews. This trimming operation may involve extracting or identifying the relevant portion of the video based on predefined time limits. By only allowing the first part of the movie to be used for preview generation, the system can ensure that the previews remain engaging without revealing major twists or plot developments that typically occur later in the film. Similar yet different time-based constraints may be utilized for different media formats (television series, educational content, etc.).

In one or more embodiments of the invention, the system may pre-process the media item by applying genre-based constraints. For example, in a horror movie, scenes containing excessive gore or explicit content may be automatically filtered out to create previews that are appropriate for general audiences. The content moderation module 171 analyzes the media file and flags segments that exceed predefined thresholds for violence, nudity, or other restricted content. These flagged portions are excluded from the pool of available segments for preview generation, ensuring that the resulting previews meet content guidelines and platform requirements.

Additionally, pre-processing may include identifying and removing slow-paced or low-action segments that may not be suitable for generating engaging previews. In this embodiment, the computer vision module 173 and the audio analysis module 172 work together to analyze the visual and audio elements of the media item, detecting moments where little to no significant action occurs, such as extended dialogue scenes or static camera shots. These low-energy sections may be deprioritized or filtered out to increase the likelihood that the preview showcases more dynamic or engaging content, such as action sequences, critical plot moments, or high-tension dialogue exchanges. In this way, the preview generation system 150 ensures that the media content used for preview generation is relevant, appropriate, and aligned with the desired goals, such as avoiding spoilers.

### Shot Detection

In one or more embodiments of the invention, the computer vision module 173 includes functionality to analyze the visual content of the source video and identify a set of shots. A shot, for purposes of this disclosure, refers to a contiguous series of frames in the video that share visual or other characteristics, such as camera angles, lighting, or scene content. The computer vision module is responsible for processing the video file and grouping frames into distinct shots based on visual similarity. The grouping can be performed using various image recognition techniques, such as frame similarity analysis, histogram comparison, or edge detection.

The computer vision module 173 also includes functionality to generate shot timestamps, which correspond to the start and end times of each identified shot. These timestamps are recorded and used in downstream processes, such as preview generation or content moderation. For example, if a source video contains a scene with several changes in camera angles, the computer vision module detects each change and generates the appropriate start and end timestamps for the shots. This ensures that preview generation relies on accurate segment boundaries when selecting which parts of the video to include.

### Text Metadata Generation

In one or more embodiments of the invention, the preview generation system 150 further includes an audio analysis module 172 comprising functionality to obtain text metadata of the source video. Text metadata may be extracted from embedded subtitle files or generated through speech-to-text transcription if no subtitles are available. In one or more embodiments, the audio analysis module processes the source video to capture dialogue and other spoken content as text metadata.

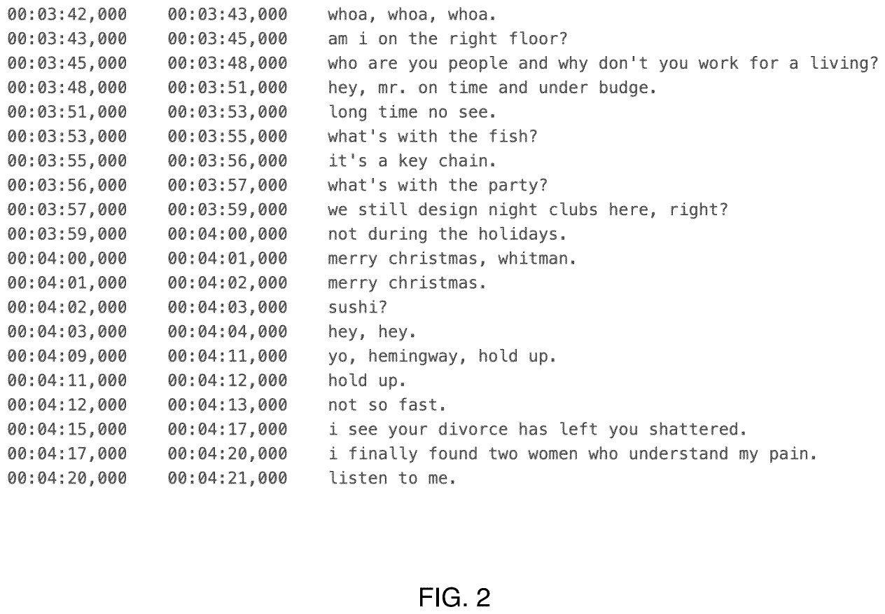

In one or more embodiments of the invention, the audio analysis module 172 is configured to generate a set of text metadata from the source video. This metadata may include groupings of subtitles, where each grouping is linked to a specific timestamp indicating the occurrence of the corresponding subtitles within the source video. The subtitles may be sourced from existing subtitle files, or in the absence of such files, the system may invoke a speech-to-text module to transcribe audio into timestamped text metadata. Each element of the text metadata may represent a short sequence of dialog or description of an event. FIG. 2 depicts an example of speech-to-text generated text metadata, each corresponding to a starting timestamp and an ending timestamp.

In one or more embodiments of the invention, the audio analysis module 172 is configured to generate a set of text metadata by grouping the subtitles according to the shot timestamps generated by the computer vision module. Each grouping of subtitles corresponds to one or more timestamps that mark the occurrence of specific shots in the video. For example, if the computer vision module identifies a shot lasting from minute 2:00 to 2:10, and subtitles indicate that dialogue occurs during this period, the audio analysis module groups the subtitles with the associated shot timestamp. This allows for the text metadata to be synchronized with the visual segments of the video, facilitating more accurate generation of media previews and enabling further content analysis, such as content moderation or entity detection. In one embodiment, the audio analysis module 172 includes functionality to cluster dialog or other text content for continuity, such that dialog in the text metadata is grouped across multiple shots.

In one or more embodiments of the invention, the audio analysis module 172 comprises a machine learning model configured to perform the generation and grouping of text metadata, specifically to organize sections of subtitles or descriptions into coherent groupings based on both temporal and contextual factors. The machine learning model may be trained on various dialogue patterns, scene transitions, and narrative structures to intelligently segment and group the subtitles. Instead of merely relying on the shot timestamps provided by the computer vision module 173, the machine learning model can analyze the content of the text metadata itself, identifying thematic shifts, changes in conversation flow, or important narrative transitions. For example, the model may detect that a dialogue spans multiple shots or scenes but remains part of the same conversational thread, prompting it to group the corresponding subtitles together despite the visual scene transitions.

By applying natural language processing (NLP) techniques, the system is configured to identify semantic relationships between dialogue and events within the video, allowing it to group together subtitles or narrative descriptions that reflect a single event or cohesive dialogue exchange, even if spread over multiple shots. For instance, in a scene where multiple camera angles capture a conversation between two characters, the machine learning model groups all relevant subtitles into one coherent segment, even if the camera switches between the characters.

### Entity Detection

In one or more embodiments of the invention, the entity detection module 174 includes functionality to invoke an entity recognition model on at least one frame of each of the set of candidate previews. The entity recognition model is an artificial intelligence model designed to identify and tag specific entities within the audio/visual content. These entities may include people, such as actors or public figures, as well as objects, places, or brands that appear in the media.

The entity detection module 174 applies the entity recognition model to frames from each candidate preview to detect the presence of specific persons or objects. For example, in a movie scene candidate preview, the entity detection model may recognize a famous actor, such as “John Doe,” and annotate the preview with corresponding person metadata indicating the actor's identity. This metadata can also include additional information, such as the actor's role, the significance of the scene, or the time in which the entity appears.

The entity detection module 174 is responsible for generating and annotating at least a subset of the set of candidate previews with this person or object metadata. These annotations are used to enhance the subsequent processes, such as organizing, filtering, or prioritizing previews based on user preferences or relevance. For instance, a preview featuring a prominent actor may be ranked higher in a personalized selection process, based on metadata that indicates the actor's importance to the video segment.

In one or more embodiments of the invention, the output of the entity detection module 174 can be used to determine whether specific entity-related criteria, such as the presence of a main actor, are met for each candidate preview. The entity detection module identifies and annotates key individuals, objects, brands or other entities within the visual content, generating person metadata that includes information about the presence of recognized actors or other significant entities. For example, the preview generation system 150 may require that each candidate preview feature at least one main actor from the media. The entity detection output is evaluated against this requirement, ensuring that previews that do not include a main actor or important character are either deprioritized or eliminated from the set of candidate previews. The ranking module 175 may further use the entity detection data to score previews based on the prominence of the actor or character present, giving higher priority to previews featuring more recognizable or central figures to enhance user engagement. This process ensures that the final previews adhere to criteria that improve relevance and appeal to the target audience.

In one or more embodiments of the invention, the entity detection module 174 includes functionality to identify brands that appear in the media content. The system uses entity recognition models to detect visual or textual references to recognizable brands, such as logos, product placements, or other branded elements present in the video. Once identified, the system provides options for handling these detected brands based on predefined rules or monetization strategies.

In one embodiment, the system may be configured to automatically exclude previews that feature certain brands. For example, if a brand is associated with a restricted category or conflicts with content guidelines, the entity detection module 174 flags the preview for exclusion, ensuring that no unauthorized or restricted brand content is included in the final set of candidate previews. This exclusion functionality helps maintain compliance with platform policies or legal requirements that limit the display of certain brands within media previews.

In another embodiment, the system includes functionality to monetize the presence of detected brands by integrating with the advertising service 190. When a brand is identified in a preview, the system 150 may make this brand available for promotion through a self-service advertising platform. The advertising service 190 can interface with users, offering the opportunity to promote the identified brand within the platform. For example, the detected brand could be included in a promotional slot or associated with specific advertising campaigns, allowing the brand to leverage its presence in the media as part of a targeted marketing strategy. The self-service platform enables brand owners to view, bid on, or purchase promotional opportunities directly, enhancing the platform's ability to monetize content that includes branded elements.

### Content Moderation

In one or more embodiments of the invention, the content moderation module 171 comprises functionality to perform moderation analysis on the visual and audio content of the media. The content moderation module is responsible for determining whether any portion of the media contains material deemed prohibited or inappropriate based on predefined criteria, such as explicit nudity, graphic violence, drug use, or self-harm. The moderation analysis includes generating a content moderation score for each frame or shot, which represents the likelihood that the content within a shot violates these criteria.

To perform this analysis, the content moderation module 171 may use various techniques, such as image recognition, classification models, or neural network-based algorithms to identify prohibited content in video frames. For example, the content moderation module might analyze frames for signs of graphic violence and generate a score based on how likely the content violates moderation guidelines. In some embodiments, the module also performs audio analysis to detect inappropriate language or sounds, using speech-to-text models or other audio processing techniques.

Once the content moderation score is generated, the content moderation module 171 determines whether the score for any shot exceeds a predefined threshold. This threshold is configurable according to content policies established by the media platform or content providers. For instance, a moderation score above 0.8 (on a scale of 0 to 1) may indicate a high likelihood that a shot contains explicit nudity or graphic violence, triggering the system to flag the shot for exclusion.

If the content moderation module 171 determines that a shot exceeds the predefined threshold, it includes functionality to exclude any candidate preview that contains the flagged shot. This exclusion ensures that potentially inappropriate or prohibited content is not served to users as part of the preview set. For example, if a shot within a candidate preview contains graphic violence and the moderation score exceeds the threshold, the content moderation module will exclude that candidate preview from the final set. This automatic filtering allows for efficient removal of inappropriate content, while still allowing human curators to review the remaining previews for quality and relevance.

### Synopsis Generation

In one or more embodiments of the invention, the preview generation system 150 includes functionality to generate textual synopses of media previews, which are designed to capture the essence of the media title, including key dialogues, important events, and/or overall thematic elements. The goal of these synopses is to provide concise yet engaging summaries that represent the most intriguing and plot-driven aspects of the media. In one embodiment, the system 150 achieves this by utilizing a large language model (LLM) capable of processing the text metadata, such as subtitles or transcriptions, and extracting the most relevant information to produce these summaries.

In one or more embodiments of the invention, the LLM is invoked to generate a synopsis for each candidate preview segment by analyzing the corresponding text metadata, including subtitles, dialogue, and/or text metadata inputs grouped by ranges of timestamps related to the media content. The model is capable of recognizing important narrative elements, character interactions, and significant events within the media. Based on this analysis, the LLM generates a succinct summary that reflects the contents of each media segment.

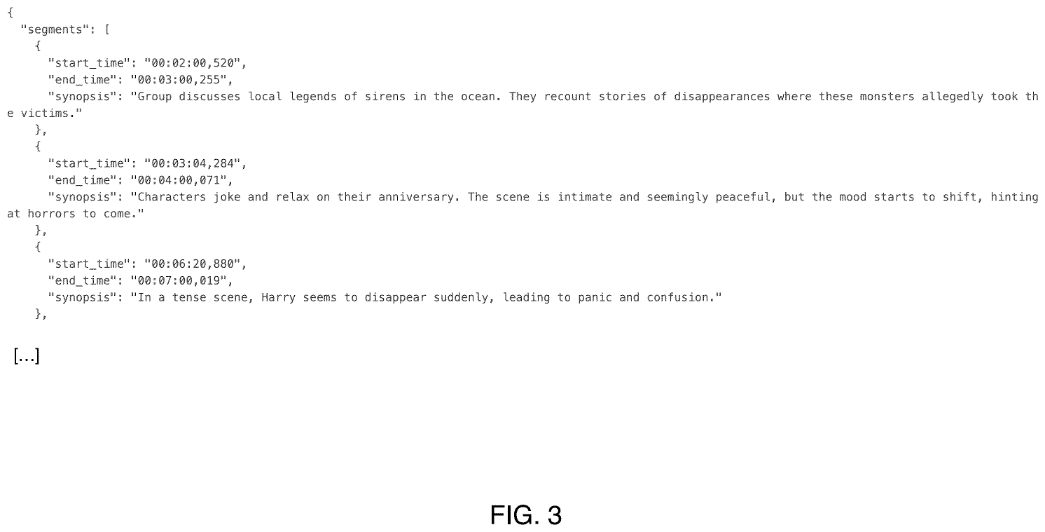

For example, as illustrated in FIG. 3, the system can generate output in a structured format, such as a JSON object, that includes the start and end times of each preview segment, along with the synopsis. The figure shows three segments, each with its own start and end time, and an associated synopsis. In one segment, the synopsis reads: “Group discusses local legends of sirens in the ocean. They recount stories of disappearances where these monsters allegedly took the victims.” This brief summary provides an engaging overview of the scene which functions as a concise preview of the media.

In another example depicted in FIG. 3, the system generates a synopsis for a more emotionally driven scene: “Characters joke and relax on their anniversary. The scene is intimate and seemingly peaceful, but the mood starts to shift, hinting at horrors to come.” This description highlights both the emotional tone and the foreshadowing of future events, giving users a glimpse into the complexity of the scene while maintaining suspense.

In one or more embodiments, the LLM may be further enhanced by providing additional contextual inputs, such as cast information, plot descriptions, or genre tags, which can help the model generate more relevant and tailored synopses for each segment. The system can output these synopses in various structured data formats, such as JSON, for integration with other modules, including the ranking module 175, which utilizes these synopses for evaluating and prioritizing candidate previews based on narrative importance and user engagement potential.

In one or more embodiments of the invention, the output of the text synopsis generation process may define a first set of candidate previews by identifying the most relevant and engaging segments of the media based on the generated synopses. Each synopsis corresponds to a one-minute (or other predefined length) segment of the source video, capturing key dialogues or events that reflect the overall plot and tone. These candidate previews, along with their associated synopses, are then passed to the ranking module 175, which is responsible for ordering the candidate previews based on various criteria, such as relevance, engagement potential, or content appropriateness. The ranking module may also eliminate one or more candidate previews that do not meet specific thresholds, such as those containing prohibited content or those deemed less engaging.

### Ranking and Outlier Detection

In one or more embodiments of the invention, the ranking module 175 includes functionality to perform ranking and outlier detection on candidate media previews. Outlier detection helps identify and exclude candidate previews that significantly deviate from expected or desired characteristics, ensuring that only high-quality, relevant previews are included in the final set presented to users. This process is based on a scoring system that evaluates each candidate preview against several criteria, such as relevance to the plot, content appropriateness, engagement potential, and visual and audio quality.

Relevance to the plot is determined by analyzing metadata from the audio analysis module 172 and the entity detection module 174 to assess how central the preview is to the storyline. Previews featuring key events or main characters receive higher scores, whereas those focused on less important or tangential content are scored lower. For example, a preview highlighting a climactic scene from the first 30 minutes of a movie, in line with spoiler-avoidance policies, may receive a high score for relevance, while a preview centered on a less significant moment may score lower. Content appropriateness is evaluated using the results of the content moderation module 171, which determines whether the preview contains prohibited or inappropriate material, such as explicit content or significant violations of moderation guidelines. Previews flagged for inappropriate content receive low scores, while those adhering to guidelines are scored higher.

Engagement potential is assessed by considering factors such as the appearance of well-known actors, dramatic moments, and the overall appeal of the preview. Metadata from the entity detection module 174 is used to determine if a preview features high-profile actors or showcases exciting scenes. Previews with such characteristics are given higher engagement scores, while less compelling segments may receive lower ones. The ranking module also evaluates the technical quality of each preview, including clear visuals, stable camera angles, and well-synced audio. Previews with lower production quality, such as shaky visuals or poor audio, are penalized, while technically proficient previews are given higher scores.

In one or more embodiments, a large language model (LLM) can be utilized in the ranking process by analyzing the textual content of the media, such as subtitles, transcriptions, or descriptions, to more accurately score the relevance of each candidate preview. The LLM can evaluate dialogue, narrative elements, and key themes in the text to determine how well a particular preview reflects the overall plot, emotional tone, or genre of the media. By processing these linguistic elements, the LLM can assign scores based on the importance of certain events, characters, or plot points present in the preview. For instance, if the LLM identifies a scene with crucial dialogue or a significant plot twist, it may score that preview higher in terms of relevance and engagement potential. Additionally, the LLM can assess the presence of spoilers or inappropriate language, contributing to content moderation and ensuring that previews align with platform guidelines.

Once each preview has been scored, the ranking module performs outlier detection by identifying previews with scores that fall outside acceptable ranges. Previews with composite scores below a certain threshold, for example, 30/100, are flagged as outliers and excluded from the final set. Additionally, previews that score extremely low in specific categories, such as content appropriateness, may be excluded even if their overall composite score is higher. For example, a preview with a high engagement score but a very low content appropriateness score may still be flagged for exclusion.

In one or more embodiments of the invention, the ranking module includes adaptive thresholds that adjust based on the overall distribution of preview scores. If all previews score low, the threshold can be lowered to include at least some in the final set, and if most previews score high, the threshold can be raised to select only the very best previews. The ranking module can also incorporate machine learning algorithms to refine the outlier detection process over time, analyzing feedback from curators or end-users to learn which previews are more likely to be selected or rejected, and adjusting its thresholds and scoring accordingly. After outlier detection, the ranking module outputs a ranked list of candidate previews, with any outliers removed, ensuring that the previews presented to users are engaging, relevant, and appropriate.

### Personalization

In one or more embodiments of the invention, the preview generation system 150 includes functionality to generate different sets of media previews for various use cases, including personalized previews tailored to specific user profiles. This functionality leverages user behavior data stored in the user repository 182, which may include viewing history, user preferences, engagement patterns, and demographic information. By accessing this data, the system can generate customized previews that align with individual user interests, thereby increasing the relevance and appeal of the content presented.

For example, if a user consistently watches action movies or content featuring specific actors, the system can prioritize generating or selecting existing previews that highlight action sequences or include those actors. The ranking module 175 plays a critical role in this process by using the user profile data to adjust the ranking of candidate previews to match the user's preferences. Additionally, the system may create different preview sets based on genre, device type, or viewing context (e.g., mobile users may receive shorter, portrait-oriented previews, while desktop users may receive longer, widescreen previews). In this way, the ranking module 175 may be configured to perform both offline (e.g., preview generation) and online ranking (e.g., preview ranking/selection), in accordance with various embodiments of the invention.

### Curation

In one or more embodiments of the invention, the preview generation system 150 includes functionality for enabling human curators to interact with the generated candidate previews through an admin interface via a client device. This interface allows curators to review, select, edit, and publish media previews before they are deployed to users on the media platform. The admin interface provides curators with various tools for fine-tuning the previews, ensuring that the final output aligns with content policies and user engagement goals. Additionally, this interface allows curators to provide qualitative feedback, which is shared with the underlying machine learning models to continuously improve their performance.

In one or more embodiments of the invention, the preview generation system 170 includes functionality to adjust the boundaries of programmatically generated clips in response to instructions from curators obtained via the admin interface. In one or more embodiments, curators can modify the start time and end time of a candidate preview to ensure that it captures the most relevant or engaging moments from the source video. The interface provides an intuitive control mechanism where curators can navigate the clip boundaries by moving forward or backward by a shot (as identified by the computer vision module 173). For example, if the preview ends a few seconds too early, a curator can advance the boundary by a single shot, thereby adjusting the preview to include a more complete scene.

In one or more embodiments of the invention, the admin interface allows for frame-level precision editing. Curators have the option to move the preview boundaries forward or backward by individual frames (or any grouping of frames if individual frame-level editing is not feasible or preferred), giving them granular control over the exact content included in the preview. This functionality is particularly useful when adjusting the timing to align with specific moments in dialogue, actions, or transitions between scenes. For example, a curator may choose to extend the start boundary of a preview by a few frames to better capture the beginning of a key moment in the video, such as a character's reaction.

In one or more embodiments of the invention, the preview generation system 170 includes functionality to receive detailed feedback from curators through the admin interface. This feedback can include adjustments made to the preview boundaries, selection or rejection of programmatically generated previews, and more verbose, qualitative feedback about why certain previews were chosen or discarded. For instance, a curator may leave comments on why a particular clip was removed due to pacing issues or because it contained a potential spoiler. This feedback is shared with the preview generation system 170 through a model feedback loop, which allows the system to learn from human curators' decisions and improve future preview generation. Feedback may be stored in a model evaluation module (not shown), which tracks edits, curations, and feedback data to continuously refine the model's accuracy in generating relevant, engaging, and compliant previews.

In one or more embodiments of the invention, the preview generation system 150, in conjunction with the admin interface, includes functionality that allows curators to handpick scenes from different parts of a media title and stitch them together to generate a more comprehensive video preview. Through the admin interface, curators are presented with tools to browse through the media content, view the available shots or segments, and select multiple scenes they deem most representative of the story, genre, or key events. This feature provides curators the flexibility to go beyond automated preview generation and create a customized preview by combining scenes that best capture the essence of the media.

Once the curator selects the desired scenes, the system 150 facilitates the stitching of these clips into a single continuous preview, ensuring smooth transitions between the selected segments. For example, a curator might choose a dramatic dialogue sequence from the beginning of the title, followed by an action-packed scene from the middle, and conclude with a climactic moment near the end. These scenes are stitched together to form a unified preview.

After curators finalize the editing and selection process, the system 150 includes functionality to publish the selected previews to the media platform for deployment. Once published, these previews are made available to users through the media streaming service 120. This workflow enables integration of automated preview generation with human oversight, enhancing both the quality of the previews and the learning capability of the system.

In one or more embodiments of the invention, the preview generation system 150 includes functionality to deploy multiple media previews for a single title, which can rotate in and out for individual users to create a perception of novelty. This feature allows the system to provide different previews of the same media item during different user sessions, ensuring that users are exposed to fresh content, even when interacting with the same title multiple times. For example, when a user accesses a movie or show, the system may initially display one preview, and during a subsequent visit, the user might see an entirely different preview that highlights other scenes or characters.

This rotation of previews is facilitated by storing multiple candidate previews for each media title, all of which are ranked and curated based on relevance, engagement potential, and content appropriateness by the ranking module 175. In some embodiments, the system 150 can also consider user behavior or preferences, displaying previews of the deployed set of previews that are tailored to what the system predicts will engage the user most effectively. The ability to rotate previews enhances user engagement by presenting varied and diverse aspects of the media, thereby keeping the content discovery experience fresh and avoiding the repetition that could result from serving the same preview repeatedly.

### Experimentation

In one or more embodiments of the invention, the preview generation system 150 includes functionality to run experiments in a production environment and view the results through the admin console. This experimental framework allows curators and system administrators to test different configurations of media previews, analyze user engagement, and optimize the preview generation process based on real-world data. The integration service 195 orchestrates these experiments by deploying different versions of media previews to user-facing platforms, while the analytics repository 183 collects data on user interactions and engagement metrics. The admin console then provides a user-friendly interface where these results can be visualized, enabling curators and administrators to evaluate the effectiveness of various preview strategies.

One of the core experimental capabilities is the ability to test varying preview lengths. Through the admin console, curators can configure the system to generate and deploy previews of different lengths for the same media title, such as 30-second, 60-second, and 90-second previews. The system, through the preview generation system 150, can then present these variations to different user cohorts, while the analytics repository 183 tracks metrics such as click-through rates, view times, and user engagement with each version. This experimentation provides insights into which preview length works best for different types of content, allowing the system to dynamically adjust its preview generation approach based on empirical data.

In addition, the system has the ability to perform an automatic comparison between manually curated previews and programmatically generated previews. The preview repository 181 stores both types of previews for the same media title, and the system can apply different strategies to select which preview to serve to users during the experiment. The system tracks performance differences between the manually curated previews, created through the admin interface by human curators, and the programmatically generated previews, which are produced by the automated modules of the preview generation system 150. The analytics repository 183 records and analyzes the comparative engagement metrics, and these results are surfaced in the admin console, enabling curators to assess which approach is more effective. This functionality provides valuable feedback for improving the automated preview generation process while also informing curators of the strengths and weaknesses of manually curated content in comparison to programmatic/AI-driven previews.

In one or more embodiments of the invention, the preview generation system 150 includes functionality to generate form factor optimized previews, ensuring that media previews are tailored for various device formats, such as mobile, desktop, or smart TVs. Specifically, the system can create portrait view optimized previews for mobile devices, which often require vertical video formats for better user experience. The computer vision module 173 and audio analysis module 172 work together to ensure that the selected preview segments fit within the constraints of different form factors. For example, in the case of mobile-optimized previews, the system analyzes and crops the visual content appropriately, adjusting the framing to focus on key actors or events that remain in view in a portrait orientation. The ranking module 175 can also prioritize clips based on their adaptability to specific form factors, ensuring that the most visually engaging previews are presented across different devices. The integration service 195 deploys these optimized previews to various platforms, automatically adjusting the content delivery based on the user's device type.

### Performance Evaluation

In one or more embodiments, the preview generation system 150 incorporates a feedback loop that uses engagement metrics, such as click-through rates, view duration, or other interactions, to evaluate the effectiveness of both programmatically generated and manually curated clips. The analytics repository 183 stores these engagement metrics, which are analyzed to determine how well the previews are performing. The system can establish threshold criteria for these engagement rates, comparing the effectiveness of automated previews with manually curated ones, or even comparing different clip lengths or formats. For example, if the engagement rate for programmatically generated previews drops below a certain threshold in comparison to manual clips, the ranking module 175 may deprioritize the automated clips, signaling the need for adjustments in the model. This feedback is then looped back into the model evaluation module, allowing the system to continuously refine the preview generation process and improve the relevance and quality of future previews.

In one or more embodiments of the invention, the preview generation system 150 includes functionality to evaluate the performance of human curators and factor that into the analysis of overall preview quality. The admin interface tracks the decisions made by curators, such as adjustments to preview boundaries, clip selections, and manual curation efforts, and logs this data in the model evaluation module. This information is used to assess the impact of curator actions on user engagement. For example, the system can compare the engagement rates of previews created or modified by a particular curator against system-generated benchmarks or against previews generated by the preview generation system 150. If a curator consistently produces previews that lead to higher engagement, their contributions can be factored more heavily into the feedback loop, and the system may prioritize certain curation strategies based on these findings. Conversely, if curator-driven previews consistently underperform, the system can flag areas for improvement or suggest more reliance on automated preview generation. This evaluation process ensures that human oversight is integrated into the system's continuous improvement strategy, balancing the strengths of manual curation with the scalability of automated processes.

### Flowcharts

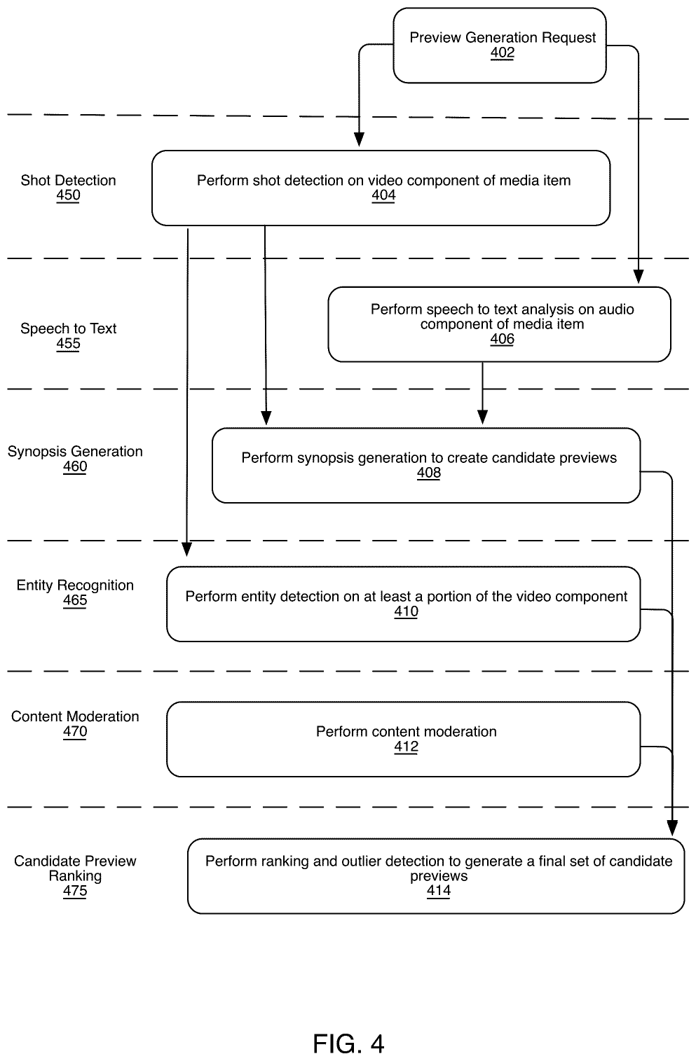

FIG. 4 illustrates a flow diagram for a media preview generation process within the preview generation system 150. The flow depicts both the sequential and parallel tasks executed to create, moderate, and rank media previews, following the receipt of a preview generation request in accordance with one or more embodiments of the invention.

The process begins with a preview generation request at step 402, which initiates the entire media preview generation workflow. This request can be triggered by a user, an automated system, or a media platform looking to generate a new set of media previews for a specific media title.

After the request is received, the system performs shot detection at step 404, which is executed by the computer vision module 173. This task identifies the boundaries of various shots in the media item by analyzing the video component. Shot detection involves grouping contiguous frames that share similar visual characteristics and generating start and end times for each shot. This step is used for determining the building blocks of candidate previews.

In parallel with shot detection, the system performs speech-to-text analysis at step 406, where the audio component of the media item is analyzed to generate text metadata, such as transcriptions or subtitles. The audio analysis module 172 converts spoken dialogue into text with corresponding timestamps. This parallelization of shot detection and speech-to-text analysis ensures that both video and audio data are processed simultaneously, saving time and enabling downstream processes to use synchronized data.

Once shot detection and speech-to-text analysis are completed, the system moves to synopsis generation at step 408. Here, the system generates synopses for candidate previews by analyzing the text metadata (such as subtitles or transcriptions) and video content. This step is managed by the text synopsis generation component, often employing a large language model to create concise descriptions of the most relevant scenes. These synopses capture key plot points or moments in the media and are associated with specific preview segments.

Next, the system performs entity recognition at step 410, utilizing the entity detection module 174. This process identifies key entities, such as actors, characters, or significant objects, within the video component. The output of this step is person metadata, which annotates candidate previews with the appearance of recognizable figures or key entities. Entity recognition is critical for ensuring that previews feature main actors or characters, a key criterion for ranking.

In parallel with entity recognition, the system performs content moderation at step 412, executed by the content moderation module 171. This step involves analyzing both the audio and video components to identify any potentially inappropriate content, such as explicit imagery, graphic violence, or offensive language. The system generates a content moderation score for each shot, and if any segment exceeds a predefined threshold for prohibited content, it is flagged for exclusion from the set of candidate previews. The parallel execution of content moderation alongside entity recognition further speeds up the process, as both tasks can occur independently.

After candidate previews are generated, the system moves to candidate preview ranking and outlier detection at step 414, executed by the ranking module 175. This step ranks the set of candidate previews based on a combination of factors, including relevance, engagement potential, content moderation results, and entity presence. Additionally, outlier detection is performed to identify and exclude any previews that deviate significantly from the desired criteria (e.g., previews that are too long, too short, or contain excessive inappropriate content). The final output of this process is a ranked and filtered set of previews that are ready for deployment to the media platform.

The diagram also demonstrates a mix of parallel and serial processes. Parallel tasks, such as shot detection (404) and speech-to-text (406), as well as entity recognition (410) and content moderation (412), occur simultaneously to improve efficiency and reduce processing time. Serial tasks, like moving from synopsis generation (408) to ranking (414), happen in sequence, as they depend on the output of earlier steps. Various other configurations may further optimize through the use of other parallelization or computational strategies.

In one or more embodiments of the invention, the entire process depicted in FIG. 4 may be performed offline, allowing the preview generation system 150 to generate and store media previews in advance. Once the previews are created, including shot detection, synopsis generation, entity recognition, content moderation, and ranking, they can be stored in the preview repository 181. This allows the system to have a ready-to-serve set of previews that can be accessed and delivered to users at a later time. In a subsequent online process, the stored previews can be further ranked, filtered, searched, or selected based on real-time user preferences, engagement data, or specific content requests. This offline-to-online workflow optimizes processing efficiency by decoupling the intensive preview generation steps from the real-time selection and presentation of the previews.

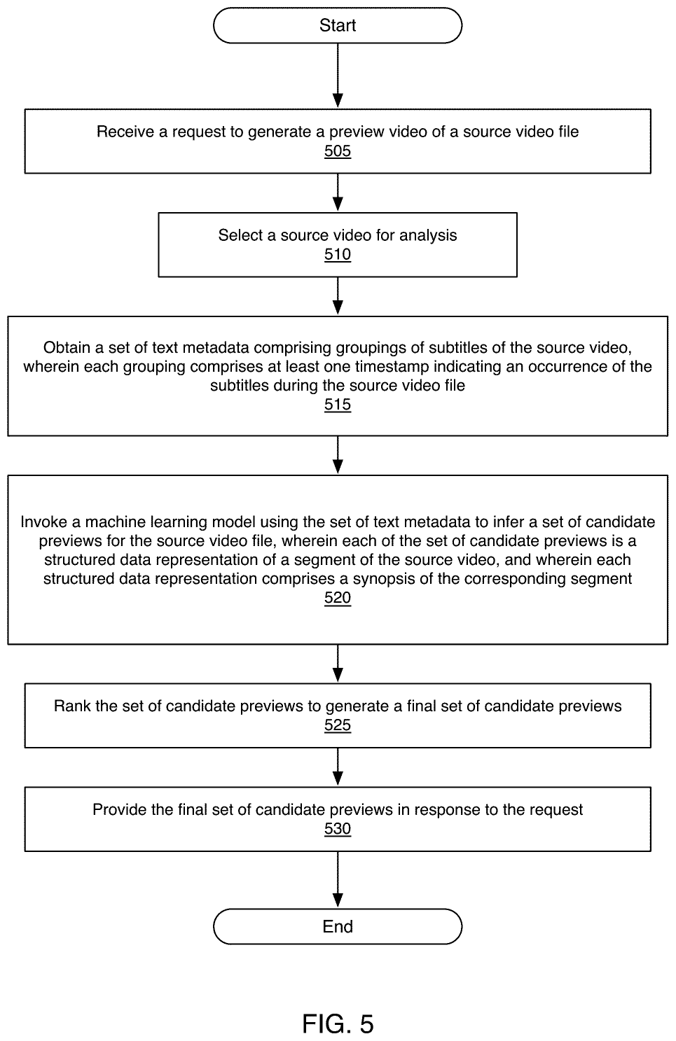

FIG. 5 shows a flowchart of a process for programmatic video preview generation. While the various steps in this flowchart are presented and described sequentially, one of ordinary skill in the art will appreciate that some or all of the steps can be executed in different orders, and some or all of the steps can be executed in parallel. Further, in one or more embodiments, one or more of the steps described below can be omitted, repeated, and/or performed in a different order. Accordingly, the specific arrangement of steps shown in FIG. 5 should not be construed as limiting the scope of the invention.

In STEP 505, a request is received to generate a preview video for a source video file. The request may come from various sources, such as a media platform, a user, or an automated system. The request can specify parameters such as the desired length of the preview, content restrictions, or particular focus areas for the preview.

In STEP 510, a source video is identified for analysis. This may involve retrieving the video from a media repository or database. The selected video may include associated metadata, such as subtitles, audio tracks, or descriptive data, which can be used in the subsequent steps.

In STEP 515, a set of text metadata is obtained, comprising groupings of subtitles of the source video. Each grouping contains at least one timestamp indicating the occurrence of the subtitles during the source video file. This metadata may be extracted from pre-existing subtitle files or generated through speech-to-text transcription if no subtitles are available. The grouping of subtitles allows for text metadata to be aligned with corresponding video segments, which can later be used to infer content relevant to the video preview.

In STEP 520, a machine learning model is invoked using the set of text metadata to infer a set of candidate previews for the source video. Each candidate preview is a structured data representation of a segment of the source video, and each structured data representation includes a synopsis of the corresponding segment. The machine learning model may analyze the text metadata to identify key events, dialogues, or scenes that are relevant for generating an engaging and representative preview.

In STEP 525, the set of candidate previews is ranked to generate a final set of candidate previews. The ranking may be based on various factors such as the presence of key actors, the relevance of the scene to the overall plot, or content moderation scores. Outlier detection may also be applied to exclude previews that fall outside certain thresholds or quality standards.

In STEP 530, the final set of candidate previews is provided in response to the request. The previews may be delivered to a media platform, user interface, or other destination where they can be viewed by users. Depending on the configuration, the previews may be further customized or filtered based on user preferences or other criteria before they are displayed.

While the present disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. Some of the steps may be performed simultaneously. For example, in certain circumstances, multitasking and parallel processing may be advantageous. The various example methods described and/or illustrated herein may also omit one or more of the steps described or illustrated herein or include additional steps in addition to those disclosed.

Embodiments may be implemented on a specialized computer system. The specialized computing system can include one or more modified mobile devices (e.g., laptop computer, smart phone, personal digital assistant, tablet computer, or other mobile device), desktop computers, servers, blades in a server chassis, or any other type of computing device(s) that include at least the minimum processing power, memory, and input and output device(s) to perform one or more embodiments.

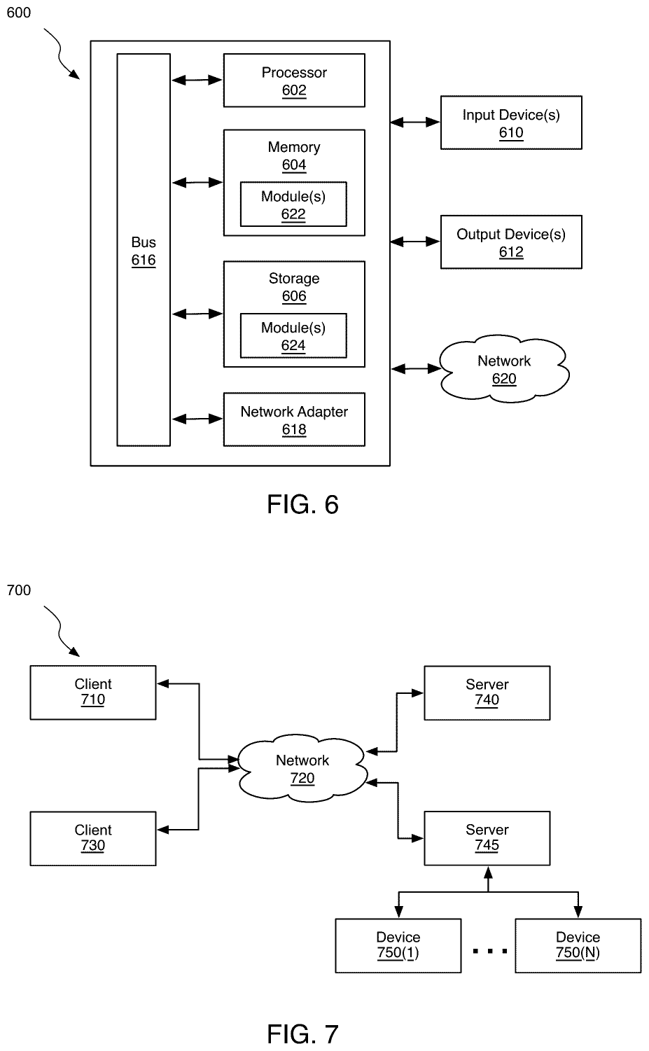

For example, as shown in FIG. 6, the computing system 600 may include one or more computer processor(s) 602, associated memory 604 (e.g., random access memory (RAM), cache memory, flash memory, etc.), one or more storage device(s) 606 (e.g., a hard disk, an optical drive such as a compact disk (CD) drive or digital versatile disk (DVD) drive, a flash memory stick, etc.), a bus 616, and numerous other elements and functionalities. The computer processor(s) 602 may be an integrated circuit for processing instructions. For example, the computer processor(s) may be one or more cores or micro-cores of a processor.

In one or more embodiments, the computer processor(s) 602 may be an integrated circuit for processing instructions. For example, the computer processor(s) 602 may be one or more cores or micro-cores of a processor. The computer processor(s) 602 can implement/execute software modules stored by computing system 600, such as module(s) 622 stored in memory 604 or module(s) 624 stored in storage 606. For example, one or more of the modules described herein can be stored in memory 604 or storage 606, where they can be accessed and processed by the computer processor 602. In one or more embodiments, the computer processor(s) 602 can be a special-purpose processor where software instructions are incorporated into the actual processor design.

The computing system 600 may also include one or more input device(s) 610, such as a touchscreen, keyboard, mouse, microphone, touchpad, electronic pen, or any other type of input device. Further, the computing system 600 may include one or more output device(s) 612, such as a screen (e.g., a liquid crystal display (LCD), a plasma display, touchscreen, or other display device), a printer, external storage, or any other output device. The computing system 600 may be connected to a network 620 (e.g., a local area network (LAN), a wide area network (WAN) such as the Internet, mobile network, or any other type of network) via a network interface connection 618. The input and output device(s) may be locally or remotely connected (e.g., via the network 620) to the computer processor(s) 602, memory 604, and storage device(s) 606.

One or more elements of the aforementioned computing system 600 may be located at a remote location and connected to the other elements over a network 620. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface.

One or more elements of the above-described systems may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems and/or flowcharts. Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

FIG. 7 is a block diagram of an example of a network architecture 700 in which client systems 710 and 730, and servers 740 and 745, may be coupled to a network 720. Network 720 may be the same as or similar to network 720. Client systems 710 and 730 generally represent any type or form of computing device or system, such as client devices (e.g., portable computers, smart phones, tablets, smart TVs, etc.).

Similarly, servers 740 and 745 generally represent computing devices or systems, such as application servers or database servers, configured to provide various database services and/or run certain software applications. Network 720 generally represents any telecommunication or computer network including, for example, an intranet, a wide area network (WAN), a local area network (LAN), a personal area network (PAN), or the Internet.

With reference to computing system 700 of FIG. 7, a communication interface, such as network adapter 718, may be used to provide connectivity between each client system 710 and 730, and network 720. Client systems 710 and 730 may be able to access information on server 740 or 745 using, for example, a Web browser, thin client application, or other client software. Such software may allow client systems 710 and 730 to access data hosted by server 740, server 745, or storage devices 750(1)-(N). Although FIG. 7 depicts the use of a network (such as the Internet) for exchanging data, the embodiments described herein are not limited to the Internet or any particular network-based environment.

In one embodiment, all or a portion of one or more of the example embodiments disclosed herein are encoded as a computer program and loaded onto and executed by server 740, server 745, storage devices 750(1)-(N), or any combination thereof. All or a portion of one or more of the example embodiments disclosed herein may also be encoded as a computer program, stored in server 740, run by server 745, and distributed to client systems 710 and 730 over network 720.

Although components of one or more systems disclosed herein may be depicted as being directly communicatively coupled to one another, this is not necessarily the case. For example, one or more of the components may be communicatively coupled via a distributed computing system, a cloud computing system, or a networked computer system communicating via the Internet.

And although only one computer system may be depicted herein, it should be appreciated that this one computer system may represent many computer systems, arranged in a central or distributed fashion. For example, such computer systems may be organized as a central cloud and/or may be distributed geographically or logically to edges of a system such as a content/data delivery network or other arrangement. It is understood that virtually any number of intermediary networking devices, such as switches, routers, servers, etc., may be used to facilitate communication.

One or more elements of the aforementioned computing system 700 may be located at a remote location and connected to the other elements over a network 720. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

One or more elements of the above-described systems (e.g., FIGS. 1A-1C) may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems (e.g., FIGS. 1A-1C) and/or flowcharts (e.g., FIG. 5). Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

It is understood that a “set” can include one or more elements. It is also understood that a “subset” of the set may be a set of which all the elements are contained in the set. In other words, the subset can include fewer elements than the set or all the elements of the set (i.e., the subset can be the same as the set).

While the invention has been described with respect to a limited number of embodiments, those skilled in the art, having benefit of this disclosure, will appreciate that other embodiments may be devised that do not depart from the scope of the invention as disclosed herein.

What is claimed is:

1. A system for media preview generation, comprising:
a computer processor;
a preview generation system executing on the computer processor, comprising functionality to:
receive a request to generate a preview video of a source video file;
select a source video for analysis;
obtain a set of text metadata comprising groupings of subtitles of the source video, wherein each grouping comprises at least one timestamp indicating an occurrence of the subtitles during the source video file;
invoke a machine learning model using the set of text metadata to infer a set of candidate previews for the source video file, wherein each of the set of candidate previews is a structured data representation of a segment of the source video, and wherein each structured data representation comprises a synopsis of the corresponding segment; and
provide a final set of candidate previews in response to the request; and
a ranking module comprising functionality to:
rank the set of candidate previews to generate the final set of candidate previews.

2. The system of claim 1, further comprising:
a computer vision module comprising functionality to:
identify a set of shots of the source video, wherein each shot comprises a contiguous series of frames of the source video which are grouped by similarity;
generate shot timestamps corresponding to start and end times of each shot of the set of shots; and
an audio analysis module comprising functionality to:
obtain the subtitles of the source video; and
generate the set of text metadata comprising groupings of subtitles of the source video using the shot timestamps, wherein the at least one timestamp of each grouping corresponds to at least one of the shot timestamps.

3. The system of claim 2, further comprising:
a content moderation module comprising functionality to:
perform a moderation analysis on at least one frame of each of the set of shots to generate a content moderation score;
determine that the content moderation score of at least one shot of the set of shots exceeds a predefined threshold indicating a likelihood of prohibited content; and
exclude a candidate preview of the set of candidate previews comprising the at least one shot based on determining that the content moderation score exceeds the predefined threshold.

4. The system of claim 3, wherein invoking the machine learning model to infer the set of candidate previews and performing the moderation analysis are executed in parallel.

5. The system of claim 1, further comprising:
an entity detection module comprising functionality to:
invoke an entity recognition model on at least one frame of each of the set of candidate previews to annotate at least a subset of the set of candidate previews with person metadata indicating appearance of a named actor, wherein ranking the set of candidate previews is based at least on the person metadata.

6. The system of claim 1, wherein the ranking module further comprises functionality to:
determine that at least one candidate preview of the set of candidate previews fails to meet an outlier threshold score; and
exclude the at least one candidate preview from the final set of candidate previews based.

7. The system of claim 1, wherein the preview generation system further comprises functionality to:
provide the final set of candidate previews to a client application for display to a human curator;
receive a selection of a candidate preview of the final set of previews for deployment; and
trigger a deployment of the candidate preview in response to the selection, wherein deployment of the candidate preview results in serving the candidate preview to users of a media streaming service.

8. The system of claim 7, wherein the preview generation system further comprises functionality to:
receive an instruction to modify the candidate preview from the human curator, wherein the instruction comprises at least one selected from a group consisting of: editing a boundary of the candidate preview by advancing or receding the boundary by at least one shot; and
modify the candidate preview according to the instruction.

9. The system of claim 7, wherein the preview generation system further comprises functionality to:
receive a negative annotation from the human curator for a second candidate preview of the final set of candidate previews;
exclude the second candidate preview from eligibility for deployment by the media streaming service in response to the negative annotation; and
provide the negative annotation to a model evaluation module of the preview generation system; and
the model evaluation module comprising functionality to:
obtain a plurality of feedback data comprising the negative annotation; and
generate a performance evaluation metric for a machine learning model of the ranking module using the plurality of feedback data.

10. A method for media preview generation, comprising:
receiving a request to generate a preview video of a source video file;
selecting a source video for analysis;
obtaining a set of text metadata comprising groupings of subtitles of the source video, wherein each grouping comprises at least one timestamp indicating an occurrence of the subtitles during the source video file;
invoking, by a computer processor, a machine learning model using the set of text metadata to infer a set of candidate previews for the source video file, wherein each of the set of candidate previews is a structured data representation of a segment of the source video, and wherein each structured data representation comprises a synopsis of the corresponding segment;
ranking the set of candidate previews to generate a final set of candidate previews; and
providing the final set of candidate previews in response to the request.

11. The method of claim 10, further comprising:
identifying a set of shots of the source video, wherein each shot comprises a contiguous series of frames of the source video which are grouped by similarity;
generating shot timestamps corresponding to start and end times of each shot of the set of shots;
obtaining the subtitles of the source video; and
generating the set of text metadata comprising groupings of subtitles of the source video using the shot timestamps, wherein the at least one timestamp of each grouping corresponds to at least one of the shot timestamps.

12. The method of claim 11, further comprising:
performing a moderation analysis on at least one frame of each of the set of shots to generate a content moderation score;
determining that the content moderation score of at least one shot of the set of shots exceeds a predefined threshold indicating a likelihood of prohibited content; and
excluding a candidate preview of the set of candidate previews comprising the at least one shot based on determining that the content moderation score exceeds the predefined threshold;

13. The method of claim 12, wherein invoking the machine learning model to infer the set of candidate previews and performing the moderation analysis are executed in parallel.

14. The method of claim 10, further comprising:
invoking an entity recognition model on at least one frame of each of the set of candidate previews to annotate at least a subset of the set of candidate previews with person metadata indicating appearance of a named actor, wherein ranking the set of candidate previews is based at least on the person metadata.

15. The method of claim 10, further comprising:
determining that at least one candidate preview of the set of candidate previews fails to meet an outlier threshold score; and
excluding the at least one candidate preview from the final set of candidate previews based.

16. The method of claim 10, further comprising:
providing the final set of candidate previews to a client application for display to a human curator;
receiving a selection of a candidate preview of the final set of previews for deployment; and
triggering a deployment of the candidate preview in response to the selection, wherein deployment of the candidate preview results in serving the candidate preview to users of a media streaming service.

17. The method of claim 16, further comprising:
receiving an instruction to modify the candidate preview from the human curator, wherein the instruction comprises at least one selected from a group consisting of: editing a boundary of the candidate preview by advancing or receding the boundary by at least one shot; and
modifying the candidate preview according to the instruction.

18. The method of claim 16, further comprising:
receiving a negative annotation from the human curator for a second candidate preview of the final set of candidate previews;
excluding the second candidate preview from eligibility for deployment by the media streaming service in response to the negative annotation; and
providing the negative annotation to a model evaluation module of the preview generation system;
obtaining a plurality of feedback data comprising the negative annotation; and
generating a performance evaluation metric for a machine learning model of the ranking module using the plurality of feedback data.

19. A non-transitory computer-readable storage medium comprising a plurality of instructions for media preview generation, the plurality of instructions configured to execute on at least one computer processor to enable the at least one computer processor to:
receive a request to generate a preview video of a source video file;
select a source video for analysis;
obtain a set of text metadata comprising groupings of subtitles of the source video, wherein each grouping comprises at least one timestamp indicating an occurrence of the subtitles during the source video file;
invoke a machine learning model using the set of text metadata to infer a set of candidate previews for the source video file, wherein each of the set of candidate previews is a structured data representation of a segment of the source video, and wherein each structured data representation comprises a synopsis of the corresponding segment;
rank the set of candidate previews to generate a final set of candidate previews; and
provide the final set of candidate previews in response to the request.

20. The non-transitory computer-readable storage medium of claim 19, wherein the plurality of instructions are further configured to enable the at least one computer processor to:
identify a set of shots of the source video, wherein each shot comprises a contiguous series of frames of the source video which are grouped by similarity;
generate shot timestamps corresponding to start and end times of each shot of the set of shots;
obtain the subtitles of the source video; and
generate the set of text metadata comprising groupings of subtitles of the source video using the shot timestamps, wherein the at least one timestamp of each grouping corresponds to at least one of the shot timestamps.
